(19) United States
(12) Patent Application Publication
(10) Pub. No.: US 2014/0019421 A1
(43) Pub. Date: Jan. 16, 2014

(54) Shared Architecture for Database Systems

(71) Applicant: Chandrasekaran Jagadeesan, Cupertino, CA (US)

(72) Inventor: Chandrasekaran Jagadeesan, Cupertino, CA (US)

(73) Assignee: APPLE INC., Cupertino, CA (US)

(21) Appl. No.: 13/549,386

(22) Filed: Jul. 13, 2012

(51) Int. Cl. G06F 7/00; G06F 17/30

(52) U.S. Cl. 707/687; 707/E17.032; 707/E17.005

(57) ABSTRACT

Systems, methods and computer-readable mediums are disclosed for a shared hardware and architecture for database systems. In some implementations, one or more source databases in a data warehouse can be backed up to one or more backup databases on network storage. During normal operating conditions, the backup databases are continuously updated with changes made to their corresponding source databases and metadata information for the database backup copies and database backup information are stored in a centralized repository of the system. When a source database fails (failover), the source database is replaced by its corresponding backup database on the network storage and the source database node (e.g., a server computer) is replaced by a standby node coupled to the network storage.

### TECHNICAL FIELD

This disclosure is related generally to database systems.

### BACKGROUND

A data warehouse (DW) is a database used for reporting and analysis. The data stored in the warehouse can be uploaded from operational systems (e.g., online marketplace, sales, etc.) The data may pass through an operational data store (ODS) for additional operations before they are used in the DW for reporting.

A typical Extract, Transfer and Load (ETL)-based data warehouse uses staging, integration, and access layers to house key functions. The staging layer or staging database stores raw data extracted from each of the source data systems. The integration layer integrates the data sets by transforming the data from the staging layer and storing this transformed data in an ODS database. The integrated data can then be moved to a data warehouse database, where the data is arranged into hierarchal groups called dimensions and into facts and aggregate facts. The access layer helps users retrieve data.

The process of backing up data a source database usually includes making copies of data that are used to restore the source database after a data loss event. A primary purpose of a backup is to recover data after its loss, such as by data deletion or corruption. A secondary purpose of backups is to recover data from an earlier time, according to a user-defined data retention policy configured within a backup application. Since a backup system contains at least one copy of all data, data storage requirements are considerable.

Organizing storage space and managing the backup process is a complicated undertaking A data repository model can be used to provide structure to the storage. There are many different types of data storage devices that are useful for making backups. Often there is a one to one relationship between a source database and backup database, requiring duplicate sets of computer hardware. Duplicate sets of hardware can be expensive and inefficient, resulting in a system that is difficult and expensive to scale up as the databases increase in size.

### SUMMARY

Systems, methods and computer-readable mediums are disclosed for a shared hardware and architecture for database systems. In some implementations, one or more source databases in a data warehouse can be backed up to one or more backup databases on network storage. The network storage is a physical storage that is configured to look like a single logical backup database and that is shared by the source databases. During normal operating conditions, the backup databases are continuously updated with changes made to their corresponding source databases and metadata information for the database backup copies and database backup information are stored in a centralized repository of the system. When a source database fails (failover), the source database is replaced by its corresponding backup database on the network storage and the source database node (e.g., a server computer) is replaced by a standby node coupled to the network storage. The standby node can be part of a cluster that includes a number of nodes that are configured to operate as a single logical server.

Particular implementations disclosed herein provide one or more of the following advantages. The disclosed implementations provide: 1) a fully automated process for data synchronization between source and backup databases; 2) shared hardware and architecture, eliminating one to one hardware redundancy used by conventional database architectures, resulting in reduced cost and data center foot print; 3) shared hardware and architecture for load balancing on demand and testing new releases without creating a new environment (staging environment) and adding additional hardware; and 4) a simplified architecture that increases operational efficiency.

The details of the disclosed implementations are set forth in the drawings and the description below. Other features, objects, and advantages will be apparent from the description, drawings and claims.

### DESCRIPTION OF DRAWINGS

FIG. 1 is block diagram of an exemplary shared architecture for database systems.

FIG. 2 illustrates an exemplary failover process for the shared architecture of FIG. 1.

The same reference symbol used in various drawings indicates like elements.

### DETAILED DESCRIPTION

Exemplary System

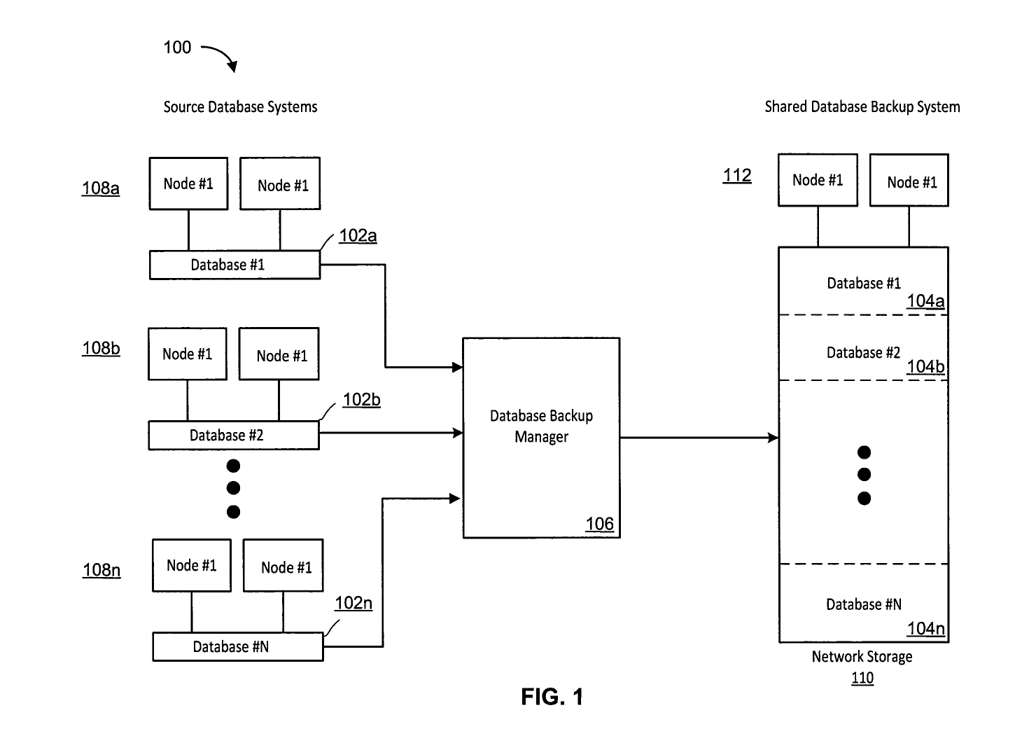

FIG. 1 is block diagram of an exemplary shared architecture 100 for database systems. In some implementations, source databases 102a-102n are coupled to backup database manager 106. Each of source databases 102a-102n is coupled, respectively, to nodes 108a-108n. The combination of a source database and its respective nodes is referred to herein as source database system. A “node” is a computer configured to operate like a server. Nodes 108a-108n can perform database management operations on source databases 102a-102n. Nodes 108a-108n can each be a cluster of servers, such as an Oracle® Real Application Cluster (RAC) that uses Oracle® Clusterware.

In some implementations, one or more nodes 108a-108n can run a software package that implements a database management system (DBMS). The software package can include computer programs that control the creation, maintenance, and use of a database. The DBMS allows different user application programs to access concurrently the same database. The DBMS may use a variety of database models, including but not limited to the relational model or the object model to describe and support applications. The DBMS can support query languages and database languages. The query and database languages can be used to organize the database and to retrieve and present information (e.g., reports). The DBMS can also provide facilities for controlling data access, enforcing data integrity, managing concurrency control, and recovering the database after failures and restoring it from backup databases. An example DBMS is Oracle® RDBMS developed by Oracle Inc., of Redwood City, Calif. USA.

Database backup manager 106 is coupled to network storage 110, which is configured to store backup databases 104a-104n, corresponding to source databases 102a-102n. Network storage 110 can include a number of hardware storage devices that are coupled together and configured to form a single logical storage device. Database backup manager 106 can perform backup and restore operations for source databases 102a-102n. For example, database backup manager 106 can provide snapshots of data from one or more of source databases 102a-102n and write the snapshots to backup databases 104a-104n. In some implementations, database backup manager 106 performs incremental data backup where changes to one or more source databases 102a-102n are used to update or synchronize to corresponding one or more backup databases 104a-104n. An example database backup manager 106 can be Snap Manager® for Oracle® (SMO), developed by NetApp® Inc. of Sunnyvale, Calif. USA. Database backup manager 106 can maintain metadata information about various database copies and backup information in a centralized repository (not shown).

Network storage 110 is coupled to standby nodes 112. Standby nodes 112 can be a cluster of servers, such as an Oracle® RAC that uses Oracle® Clusterware. Database backup manager 106 continuously synchronizes changes to source databases 102a-102n to corresponding backup databases 104a-104n. In the event of failover of a source database system (e.g., source database 102a and associated nodes 108a), nodes 112 will be temporarily activated to replace corresponding nodes 108 of the failed source database system. Nodes 112 will be coupled to the corresponding backup database 104 in network storage 110, creating a temporary backup database system (e.g., backup database 104a and nodes 112) for the failed source database system. Additional nodes 112 can be coupled to network storage 110 to provide multiple backup database systems in case of multiple, simultaneous source database system failovers. Once the failed source database system is brought back online, the source database can be restored by its corresponding backup database on network storage.

The system described above provides shared hardware and architecture for multiple source database systems in a data warehouse, resulting in less hardware and smaller footprint, resulting in less cost and greater extensibility. Rather than having a one to one backup database system for each source database system that is activated during failover, the source database systems share a network storage configured as one large storage device, and also share standby nodes. During normal operation, a database backup manager provides incremental data synchronization/updates between source databases and corresponding backup databases on the network storage. A standby server is activated during a failover to replace the nodes of the source database system. The standby server can be part of a server cluster. The number of nodes (servers) in the standby cluster that are activated during a source database failure can be the same as the number of nodes coupled to the failed source database.

Exemplary Process

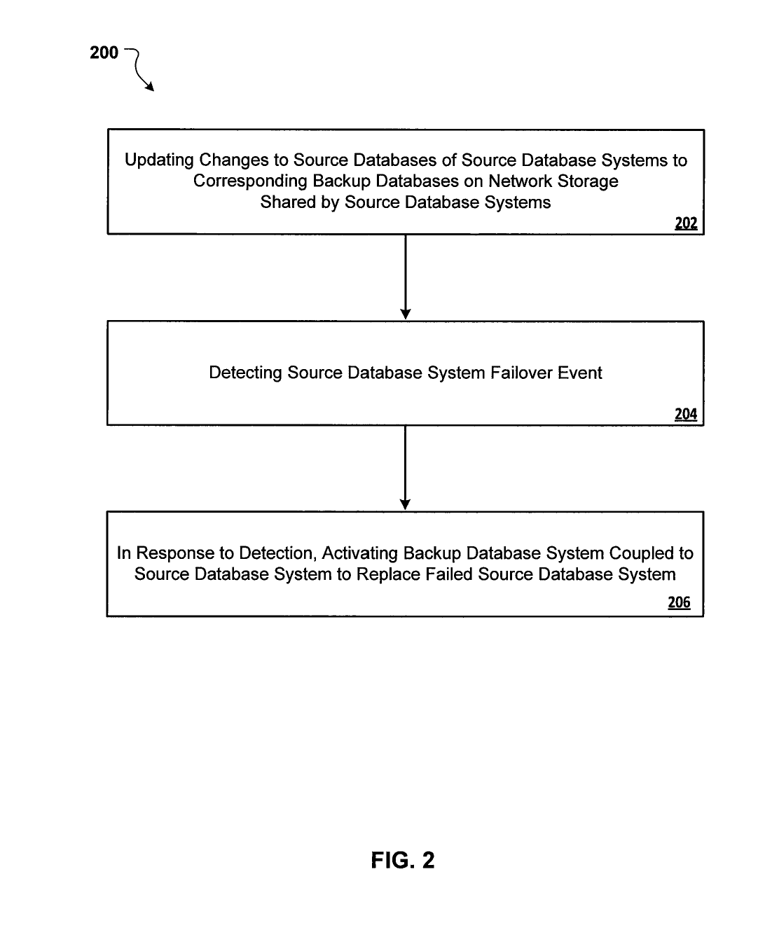

FIG. 2 illustrates an exemplary failover process 200 for system 100 of FIG. 1. Process 200 can be performed using system 100 as described in reference to FIG. 1.

In some implementations, process 200 can begin by updating changes to source databases of source database systems to corresponding backup databases on network storage that is shared by the source database systems (202). The updating can be performed by database backup management software, such as Snap Manager® for Oracle® (SMO), developed by NetApp® Inc.

Process 200 can continue by detecting a source database system failover event (204), and in response to the detection activating a backup database system coupled to the source database system to replace the failed source database system (206). The backup database system hardware and architecture are shared by the source database systems. A standby node (e.g., a server computer) coupled to the network storage is activated to replace the node coupled to the failed source database system. The standby node is coupled to the backup database corresponding to the failed source database, replacing the failed source database system.

The features described can be implemented in digital electronic circuitry or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer can communicate with mass storage devices for storing data files. These mass storage devices can include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with an author, the features can be implemented on a computer having a display device such as a CRT (cathode ray tube) or LCD (liquid crystal display) monitor for displaying information to the author and a keyboard and a pointing device such as a mouse or a trackball by which the author can provide input to the computer.

The features can be implemented in a computer system that includes a back-end component, such as a data server or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a LAN, a WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
updating changes to source databases of source database systems to corresponding backup databases on network storage shared by the source database systems;
detecting a source database system failover event; and
responsive to the failover event, activating a backup database system coupled to the source database system to replace the failed source database system, where the backup database system hardware and architecture is shared by the source database systems and includes a shared network storage storing backup databases corresponding to the source databases coupled to one or more shared standby servers,
where the method is performed by one or more hardware processors.

2. The method of claim 1, where the one or more standby servers are part of a server cluster.

3. A system comprising:
a number of source database systems each having a source database and one or more nodes;
network storage configured for storing backup databases corresponding to the source databases, where each backup database contains a copy of its corresponding source database; and
a number of standby nodes coupled to the network storage and configured to replace the one or more nodes of a corresponding source database system during a failover event involving the corresponding source database system.

4. The system of claim 3, further comprising a database backup manager configured for updating changes made to one or more source databases with one or more corresponding backup databases.

5. The system of claim 3, where the standby nodes are configured as a server cluster.
